(19) United States
(12) Patent Application Publication
(10) Pub. No.: US 2003/0041760 A1
(43) Pub. Date: Mar. 6, 2003

(54) Device for adjusting a printing press frame

(76) Inventor: Lennardt Jader, Strande (DE)

Correspondence Address: Lawrence P. Kessler, Patent Department, NexPress Solutions LLC, 1447 St. Paul Street, Rochester, NY, 14653-7103, US

(21) Appl. No.: 10/231,858

(22) Filed: Aug. 30, 2002

(30) Foreign Application Priority Data
Sep. 5, 2001 (DE) 101 43 563.0

(51) Int. Cl. B41L 1/02; B41L 3/02

(52) U.S. Cl. 101/481

(57) ABSTRACT

A device for adjusting a frame of a printing press carrying a conveyor belt relevant to printing modules in the three-dimensional axial directions. At least a first guide is provided on the frame for guiding a plate arranged on the frame in a horizontal direction x lengthwise to the frame by a first guiding component for adjusting the frame in the appropriate direction, whereby two walls perpendicular to the plate are arranged parallel to each other. Second guides are provided in a vertical direction y to the frame, on which two movable guiding components are positioned, and between the two guiding components, a third guiding component is arranged, which can be moved to the third guides on the second guiding components in the direction z to the flat surface of the frame.

### FIELD OF THE INVENTION

This invention relates in general to adjusting the frame of a printing press, and more particularly to adjusting a printing press frame carrying a conveyor belt with respect to printing modules.

### BACKGROUND OF THE INVENTION

In printing presses, transporting frames extend on which conveyor belts are stretched. Printing stock is transported on the conveyor belts and provided with tonered images by the printing modules arranged close to the conveyor belts. The exact alignment of the printing drums of the printing module with the printing stock is of crucial importance in this context. It is important that the narrow bearing surface of the printing drum on the printing stock, which is also described as nip or compression cleavage, is positioned with great precision on the printing stock. Shifting of the nip leads to printing errors on the printing stock, as can easily be understood.

On this subject of register control, the state of the art proposes a great number of solutions that basically concern the control of the register during the run of the printing press. However, with respect to the conveyor belt or printing stock, the nip may already be misaligned before the printing operation. The register controls for controlling the registerability in the machine direction and transversely to the machine direction of the conveyor belt somewhat change the speed of the conveyor belt or the speed of the printing drum accordingly in the event of a misalignment in the machine direction of the conveyor belt. In the event of a misalignment transverse to the machine direction of the conveyor belt, the axial position with respect to the printing drums is somewhat altered.

Misalignments are corrected to a certain extent, but a misalignment of the height of the printing drum with respect to the conveyor belt, i.e., the distance between the printing drum and the conveyor belt or printing stock or the bearing pressure between them is not controlled by the register controls. Furthermore, there are mechanical devices that adjust the frame to the conveyor belt in the direction of the belt path and in the direction transverse to the belt path prior to the printing process, in order to achieve an optimal alignment of the frame with the printing drums for the first time or to re-establish it after a certain operating period of the printing press and in order to prevent a misalignment or a distortion of the frame. These devices include costly adjustment structures.

### SUMMARY OF THE INVENTION

The task of the invention is to provide a simple device for adjusting a printing module of a printing press with respect to the frame of the printing press. The invention solves the task, whereby a device is provided for adjusting a frame of a printing press carrying a conveyor belt with respect to the printing modules, in which at least one of the first guides on the frame for guiding a plate arranged on the frame in a horizontal direction x lengthwise to the frame by a first guiding component for adjusting the frame in the appropriate direction. Vertical to the plate, two walls are arranged parallel to each other that have two guides in the vertical direction y to the frame which has two movable guiding components. Between the two guiding components, a third guiding component is arranged, which can be moved to the third guides positioned on the second guiding components in the direction z to the flat surface of the frame.

The invention, and its objects and advantages, will become more apparent in the detailed description of the preferred embodiment presented below.

### BRIEF DESCRIPTION OF THE DRAWINGS

In the detailed description of the preferred embodiment of the invention presented below, reference is made to the accompanying drawings, in which:

FIG. 1 is a view, in perspective of the printing press frame adjusting mechanism, according to this invention; and

FIG. 2 shows a top plan view of the printing press frame adjusting mechanism according to FIG. 1.

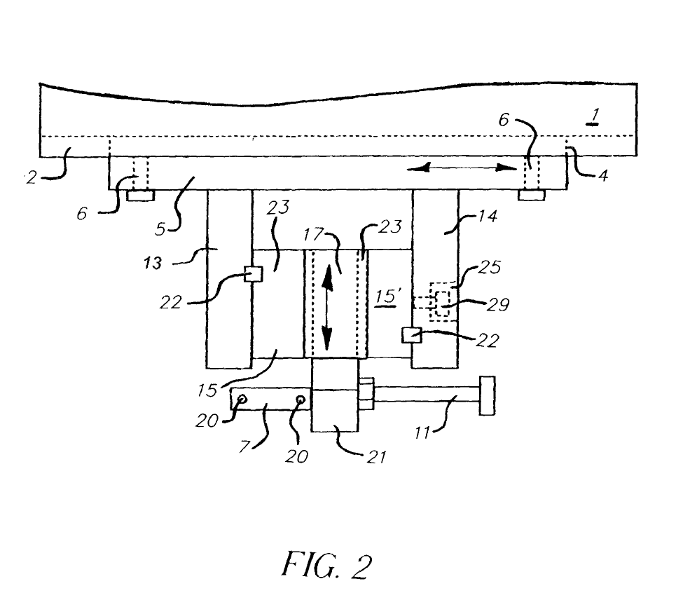

### DETAILED DESCRIPTION OF THE INVENTION

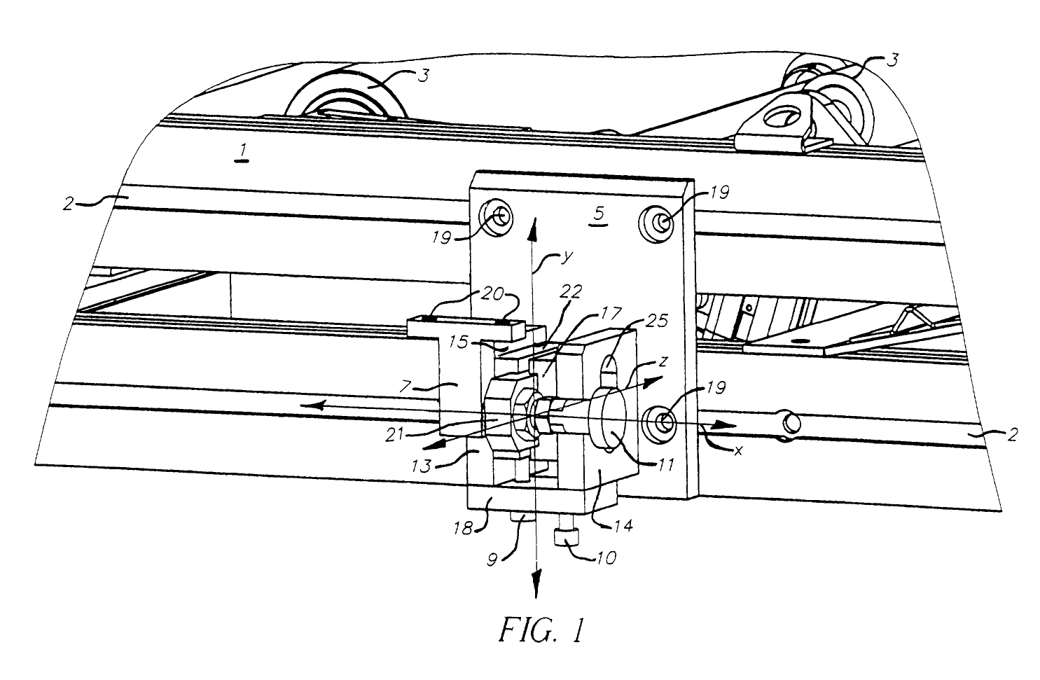

Referring now to the accompanying drawings, FIG. 1 illustrates part of a perspective view of a frame 1 of a printing press. Mounted on the frame 1 are rollers 3 on which a continuous conveyor belt or web lies and which conveys paper sheets through the printing press. It is extremely important that the conveyor belt is in the proper position, with reference to the printing drums that are positioned on top of the conveyor belt to which they are transferred. At least one horizontal first guide 2 extends to the plate 5, whereby two horizontal first guides 2 are illustrated in FIG. 1.

Accordingly, the plate 5 has first guiding components 4 that engage with the first guides 2. The engagement of the first guiding components 4 of the plate 5 with the first guides 2 makes it possible to horizontally move the plate 5 along the frame 1. As a result, the first guiding components 4 for engaging with the first guides 2 of the frame 1 can slide back and forth in the frame.

The plate 5 is attached to the frame 1 by a first set screw 6 that is inserted through the plate 5 via the first tap holes 19. Firmly connected with the plate 5 are a first side wall 13 and a second side wall 14, which are both perpendicular to the plate 5 and which preferably have recesses 25. The first side wall 13 and the second side wall 14 are connected at the underside via a floor plate 18.

Two guides 22 are located on the inner surface of the first side wall 13 and on the inner surface of the second side wall 14. The second guides 22 of the first side wall 13 and the second side wall 14 engage with a second guiding component 15 and a second guiding component 15′. A third guiding component 17 is located between the second guiding component 15 and the second guiding component 15′. Attached to the third component 17 are third guides 23 which engage with the second guiding component 15 on the one side and the second guiding component 15′ on the other side, which make it possible to slide the third guiding component 17 back and forth between the second guiding component 15 and the second guiding component 15′ in the z direction toward the frame 1.

A fastening component 21 is attached to the outer end face of the third guiding component 17. The fastening component 21 has a hole for the insertion of a dowel 11. On one side, the fastening component 21 has a support 7 with two holes 20 on its top side, and on the side, the dowel 11. The support 7 is connected with the fastening component 21 by a bushing/pin connection, whereby a bushing or a recess, which is also known as a pit, is located on the fastening component 21, into which the pin on the fastening component is inserted and which forms a secure connection between the fastening component 21 and the support 7.

A second set screw 9 and an adjusting screw 10 extend through the floor plate 18 via tap holes. The second adjusting screw 10 is inserted as seen from below behind the floor plate 18 in a thread on the underside of the second guiding component 15. As seen from below, the thread of the adjusting screw 10 is inserted behind the floor plate 18 into a thread in the underside of the second guiding component 15′. Located in a recess 25 of the second side wall 14 is a third set screw 29, which extends through the second side wall 14 and which is inserted in the side wall that is turned away from the second side wall 14 of the second guiding component 15′.

The function of the invention is as follows. If it is determined that the nip or compression cleavage of the printing press is incorrectly positioned, i.e., the printing drum is misaligned with the conveyor belt, the device ensures the mechanical adjustment of the nip with respect to the conveyor belt. Such misalignments occur, for example, when the frame is moved from its idle position during maintenance.

A deviation in the approximately horizontal direction lengthwise to the frame indicated by the x arrows is corrected by pulling or pushing on the dowel 11 in the x direction. To this end, the dowel 11 is removed by pulling it out of its secured position, whereby a pin of the dowel 11 is pulled out of the fastening component 21. Then the device is moved to the left or the right according to FIG. 1 by pulling or pushing in the x direction, against which the frame 1 remains in a fixed position. The pulling or pushing causes the first guiding component 4 of the plate 5 to move into the first guides 2 with the plate 5 in the respective horizontal direction lengthwise to the frame 1. The second guiding components 15, 15′ and the third guiding component 17 remain fixed in their position during this process. The pulling or pressing of the dowel 11 thus causes a shifting of the printing module connected with the support by a clamping device in the first guides 2.

Once the device has been moved in the desired manner in the x direction, the dowel 11 is locked in a secured position, and the printing module is positioned in a fixed alignment with the frame 1. Since the frame 1 remains in a fixed position and is not moved, while the support 7 on the printing module is moved, the alignment of the printing module with respect to the to the frame 1 is altered and corrected. The device is moved in the direction of the z arrows in a similar manner as described above. The third set screw 29 is loosened for this purpose, i.e., the bearing pressure of the third set screw 29 is reduced laterally to the second guiding component 15′ by the second side wall 14. Pushing or pulling the dowel 11 in the direction of the z arrow moves the third guiding component 17, which is connected with the dowel 11 by a fastening component 21, backwards or forwards relevant to the observer level according to FIG. 1. During this process, the third guiding component 17 slides to the third guides 23, which protrude from the second guiding component 15 and from the second guiding component 15′, along it. The third guiding component 17 has recesses for this purpose, which, engage the third guides 23, similar to the manner in which the second guides 22 engage the second guiding components 15, 15′. In this manner, the printing module connected with the support 7 can be moved on both sides in the z direction, whereby the frame 1 remains fixed in its position. Once the device has been moved in the desired z direction, the third set screw 29 is securely tightened, i.e. the bearing pressure of the third set screw 29 on the second guiding component 15′ is increased and the adjusted z direction is set.

The printing module is now located in a fixed alignment with the frame 1. Both of the adjustments of the device in the x direction and in the z direction described above are only exemplary; further possibilities of moving the third guiding component 17 and the plate 5 with the first guiding component 4 are conceivable, particularly adjustments by micrometer screws. However, tests have shown that the sensitivity of the above-mentioned manual adjustments for the targeted registerability of printing presses, in which the printing module is manually adjusted with respect to the frame 1, is sufficient.

In conclusion, the adjustment of the device in the y direction is described. To this end, the second set screw 9 is loosened, which is inserted in the second guiding component 15 in the idle position and sets the device in the y direction. This makes it possible to move the device in the y direction perpendicular to the frame 1. By turning the set screw 10, which is inserted into a thread of the second guiding component 15′, the second guiding component 15′ together with the second guiding component 15 and the third guiding component 17 are moved upward, whereby the second guiding components 15, 15′ slide along to the second guides 22 and the third guiding component 17 is fastened to the second guiding components 15, 15′ and moves with them. The adjusting screw 10 with the corresponding tapped hole in the second guiding component 15″ makes it possible to adjust the device in the y direction in the micrometer range. The fastening component 21 is, as mentioned, connected with the third guiding component 17, so that the printing module is moved up or down in the y direction by the support 7 at the fastening component 21. Following the precise adjustment of the position in the y direction in the micrometer range, the second set screw 9 is securely tightened in such a way that it is inserted in the second guiding component 15, and thus locks the second guiding component 15′ and the third guiding component 17 into position. By this setting, the device and the printing module are set in the y direction.

The invention has been described in detail with particular reference to certain preferred embodiments thereof, but it will be understood that variations and modifications can be effected within the spirit and scope of the invention.

### Parts List

1 Frame

2 First guides

3 Rollers

4 First guiding component

5 Plate

6 First set screw

7 Support

9 Second set screw

10 Adjusting screw

11 Dowel

13 First side wall

14 Second side wall

15 Second guiding component

15′ Second guiding component

17 Third guiding component

18 Floor plate

19 First tap holes

20 Second tap holes

21 Fastening component

22 Second guides

23 Third guides

25 Recess

29 Third set screw

What is claimed is:

1. Device for adjusting a frame (1) of a printing press carrying a conveyor belt with respect to printing modules, characterized by at least a first guide (2) on the frame (1) for guiding a plate (5) arranged on a frame (1) in the horizontal direction x lengthwise to the frame (1) by a first guiding component (4) for adjusting the frame (1) in the appropriate direction, whereby two walls (13, 14) perpendicular to the plate (5) are arranged parallel to each other, which have two guides (22) in the vertical direction y to the frame (1), on which two movable guiding components are positioned, and, between the two guiding components (15, 15′), a third guiding component 17 is arranged, which can be moved to third guides (23) on the two guiding components (15, 15′) in the z direction to the flat surface of the frame (1).

2. Device according to claim 1, characterized in that the device can be moved in the vertical direction y by an adjusting screw (10), and in the horizontal direction x and in the z direction to the flat surface by manual pulling and pushing movements along the guides (2, 22, 23).

3. Device according to claim 2, characterized by a dowel (11) for moving the device in the horizontal direction x and in the direction of the flat surface z.

4. Device according to one of the claim 2, characterized in that the guiding components (4, 15, 15′, 17) are arranged on the guides (2, 22, 23) with clamping devices, whereby the guiding components (4, 15, 15′, 17) can be extended into the guides (2, 22, 23).

5. Device according to one of the claim 2, characterized in that the device can be fastened by at least a first set screw (6) in the direction x to the frame (1), by a second set screw (9) in a particular position with respect to the vertical direction y to the frame (1) and by a third set screw (29) in the direction z to the flat surface.
